(19) United States
(12) Patent Application Publication
(10) Pub. No.: US 2021/0108669 A1
(43) Pub. Date: Apr. 15, 2021

(54) Screw

(71) Applicant: Arnold Umformtechnik GmbH & Co. KG, Forchtenberg-Ernsbach (DE)

(72) Inventors: Yannik Hieber, Öhringen (DE); Georg Vogel, Ingelfingen (DE)

(21) Appl. No.: 16/464,500

(22) PCT Filed: Nov. 29, 2017
(86) PCT No.: PCT/EP2017/080851

§ 371 Date: May 28, 2019

(30) Foreign Application Priority Data
Nov. 30, 2016 (DE) 20 2016 007 445.9

(51) Int. Cl. F16B 35/06

(52) U.S. Cl. CPC F16B 35/065

(57) ABSTRACT

The invention relates to a screw having a screw head and a screw shank, wherein the screw shank is provided at least partially with a thread, characterized in that a periphery of the screw head is provided with a plurality of riblike protrusions protruding in a radial direction.

The invention relates to a screw having a screw head and a screw shank, wherein the screw shank is provided at least partially with a thread.

The invention is intended to provide a screw that can be inserted into a coated or hard material without destroying the surface thereof in the region surrounding the screw head.

To this end, according to the invention, a screw having a screw head and a screw shank is provided, wherein the screw shank is provided at least partially with a thread, wherein a periphery of the screw head is provided with a plurality of riblike protrusions protruding in a radial direction.

On account of the riblike protrusions protruding in a radial direction, the surface of a hard material, in particular a coating, can be milled open or milled off when the screw is screwed in. As a result, when the screw head is countersunk, no stresses or deformations arise in the surface or coating of the material. Thus, without it being necessary to predrill a hole having the outside diameter of the screw head, the screw can also be screwed into hard materials or materials with a hard coating until the screw head is arranged substantially flush with the surface of the material.

In one development of the invention, the lower end, located on the side of the screw shank, of each protrusion is provided with a tip and/or cutting edge.

On account of the tips and/or cutting edges at the ends of the protrusions, the surface of a hard material or a coating can be cut open cleanly while the screw is being screwed in. As a result, while the screw is being countersunk, no stresses arise in the surface or coating of the material, which act on the coating away from the screw connection, i.e. in the region surrounding the screw head. For example, specially coated wooden panels can be screwed together with the screw according to the invention without the coating of the wooden panels tearing or breaking in the region surrounding the screw head while the screw is being countersunk. Thus, it is possible to avoid for example the ingress of water through the coating and the subsequent swelling of the wood. For example, it is also possible to screw veneer plywood having a linoleum coating or some other coating to supports, wherein the screw according to the invention is at least partially countersunk in the wood in the process. The linoleum coating is cut open cleanly by the tips and/or cutting edges of the protrusions while the screw is being screwed in, and so tearing of the linoleum coating in the region surrounding the screw head is prevented. The screw according to the invention thus also makes it possible, without prior counterboring, to screw together materials that are themselves hard or brittle or are provided with a hard or brittle coating. The protrusions can be embodied for example as asymmetric cutting edges, oblique cutting edges, cross knurling, knurling with a twist, imbricated profiles, knurling-like geometries that do not necessarily have to correspond to standard knurling with a 90° crossing angle, and the like. The screw according to the invention penetrates better into coated, lacquered or sealed workpieces. The screw according to the invention thus affords advantages both for visual and for technical reasons. It is possible for example to largely prevent moisture from passing between the screw head and the material surface, since the protrusions of the screw head bear very closely against the wall of the created hole. For example, a safe electrical contact-connection of the screw can also be ensured. An underside of the screw head can be formed in various ways. For example, a planar underside of the screw is possible, which is then for example in the form of a round-head screw or mushroom head screw. The screw according to the invention can also be embodied as a countersunk screw with a frustoconical or trumpet-head-shaped head underside. The screw according to the invention does not necessarily have to be countersunk completely in the workpiece; this depends on the particular application.

In one development of the invention, the tip and/or cutting edge is located at the front in the screw-in direction of the screw.

In this way, the coating or the material is cut open by simply screwing in the screw head, before relatively significant stresses can arise in the coating or the surface of the material on account of the periphery of the screw head coming into contact with the coating.

In one development of the invention, the cutting edge extends substantially parallel to the circumference of the screw head.

In this way, while the screw head is being screwed in, a narrow, circular cut is for wed in the coating or the surface of the material.

In one development of the invention, the tips and/or cutting edges are offset radially inward with respect to the outer circumference of the screw head.

In this way, the tips and/or cutting edges cut the coating or the surface of the material open at a radius that is slightly less than the radius of the screw head. However, since the periphery of the screw head is of course provided with riblike protrusions protruding in a radial direction, the coating or the surface of the material can be additionally abraded or milled open by way of the protrusions at the periphery of the screw head. As a result, a very exact and in particular substantially watertight connection between the periphery of the screw head and the coating or the surface of the material is achieved. If the coating and/or the surface of the material has a certain elasticity, a form fit can be formed between the protrusions protruding in a radial direction and the coating or the surface of the material, this then considerably increasing the loosening torque of the screw.

In one development of the invention, the protrusions are in the form of cutting protrusions.

In one development of the invention, the cutting protrusions have been rolled on to the periphery of the screw head.

In this way, the riblike cutting protrusions protruding in a radial direction can be applied easily during the production process of the screw. The rolling on of the cutting protrusions can occur such that the tips and/or cutting edges are simultaneously formed at the lower ends of the protrusions.

In one development, the cutting protrusions intersect one another.

With cutting protrusions, it is possible for example to enhance a milling effect of the periphery of the screw head during screwing in.

In one development of the invention, the protrusions extend parallel to the longitudinal center axis of the screw shank.

The protrusions can also extend obliquely with respect to the longitudinal center axis of the screw shank. By setting an angle of the protrusions with respect to the longitudinal center axis of the screw shank, it is possible for example to control a loosening torque of the screw, but also chip removal during the countersinking of the screw according to the invention. The angle and the cross-sectional shape of the protrusions are adapted to the material in which the screws according to the invention are intended to be countersunk.

In one development of the invention, the protrusions extend at different angles to the longitudinal center axis.

In one development of the invention, the protrusions partially intersect one another.

In one development of the invention, the protrusions, as seen in an axial direction parallel to the longitudinal center axis of the screw shank, at least partially have a triangular cross section.

By way of such a triangular cross section, a cutting edge projecting in a radial direction is formed, which can favor a milling action of the protrusions.

In one development of the invention, the protrusions, as seen in an axial direction parallel to the longitudinal center axis of the screw shank, at least partially have a circle-segment-like cross section.

With such a circle-segment-like cross section, there is virtually no milling action, since no cutting edges that face radially outward are provided at the periphery of the screw head. Such a design can be used for example in the case of very sensitive or elastic coatings, for example linoleum.

In one development of the invention, the riblike protrusions, as seen in the longitudinal direction of the screw, extend only over a second portion of the periphery of the screw head that is spaced apart from the top side of the screw head, and no riblike protrusions are provided in a first portion of the periphery of the screw head immediately adjoining the top side of the screw head.

As a result of such a configuration of the periphery of the screw head, the periphery of the screw head can pass into the surface of the material in a milling or cutting manner by way of the riblike protrusions, such that the tearing and breaking of the topmost layer of the material or of a coating around the screw is avoided. When the second portion of the periphery of the screw head has already been countersunk to some extent in the material, the first portion of the periphery of the screw head, which does not have any riblike protrusions, passes into the region of the surface of the material. With the last turns, for example the last two turns up to the flush arrangement of the top side of the screw head with the surface of the material, the first portion of the periphery then comes into contact with the periphery of the opening cut or milled open by the protrusions. The periphery of the opening can then bear against the circumference of the first portion of the periphery of the screw head without riblike protrusions, with the result that the contact point between the circumference of the screw head and the surface of the material, into which the screw is screwed, can be sealed.

In one development of the invention, the first portion of the screw head immediately adjoining the top side is formed in a smooth manner.

As a result, the inner wall of the bore, formed by the riblike protrusions, in the material can bear extensively against the surface of the first portion of the periphery of the screw head, such that a good seal with respect to dirt and water can be formed. A circumferential surface of the first portion is considered to be smooth when it is cylindrical and has no protrusions or indentations. Surface roughness of the smooth first portion arises as a result of the surface treatment provided, for example electrogalvanizing or hot galvanizing.

In one development of the invention, the first portion of the periphery of the screw head, as seen in the longitudinal direction of the screw, has a height that lies between the value of the thread pitch of the thread on the screw shank and twice the value of the thread pitch.

This ensures that, with the last turns of the screw, for example the last turn or the last two turns, the first portion of the periphery of the screw head moves into the region of the wall of the bore, which was created by the riblike protrusions in the second portion of the periphery of the screw head. The inner wall of the bore produced then bears against the first portion of the periphery of the screw head over a sufficient height, in order to ensure sufficient sealing with respect to dirt and water.

Furthermore, as a result of the riblike protrusions at the periphery of the screw head, a loosening torque that is increased considerably is achieved compared with a periphery of the screw head that is smooth over its entire height. In tests, approximately twice the loosening torque was achieved compared with a smooth screw periphery. Specifically when the screws according to the invention are used for fastening loading compartment floors in trucks or trailers for trucks, this is of considerable advantage. When trucks or trailers are being driven, considerable torsions and vibrations arise, which, in the case of conventional screws, cause the screws to loosen. By contrast, the screw according to the invention does not loosen as a result of the considerably greater loosening torque.

In one development of the invention, the screw is in the form of a countersunk screw and an underside of the screw head located on the side of the screw shank is formed in a frustoconical manner.

A countersunk screw according to the invention can be screwed in without prior counterboring and without fear of cracks occurring in a surface of the workpiece in the region surrounding the screw head.

In one development of the invention, the thread on the screw shank has two portions, between which a threadless portion of the screw shank is arranged.

The threadless portion of the screw shank can be embodied in a very short manner, for example only approximately as high as half the diameter of the screw shank. The threadless portion of the screw shank has advantageously the core diameter of the screw shank. By means of such a threadless portion of the screw shank, the screw-in torque can be reduced, and space can also be created to receive chips that arise while the screw is being screwed in.

In one development of the invention, the flank height of the thread increases from the flank height 0 to the final value of the flank height from the start of the thread in the region of the end of the screw shank opposite to the screw head.

In this way, the screw can form its thread itself. For example, when a floor panel is being fastened to a substructure of a truck, only a cylindrical hole is predrilled, which then extends through the floor panel and also through the metal substructure. The screw is then screwed in and forms its thread in the metal substructure itself. As described above, the screw head is countersunk into the floor panel until the top side of the screw head is arranged more or less flush with the surface of the floor panel.

In one development of the invention, the thread on the screw shank has two thread portions, wherein a thread portion located closer to the screw head has a thread with a larger outside diameter than the outside diameter of a thread in a thread portion located further away from the screw head.

In this way, a particularly secure hold of the screw according to the invention can be achieved in a workpiece to be fastened, for example a floor panel, since the thread of the thread portion located closer to the screw head forms a thread with a larger outside diameter in the workpiece to be fastened than the thread that was formed by the thread portion located further away from the screw head.

Further features and advantages of the invention will become apparent from the claims and the following description of preferred embodiments of the invention in conjunction with the drawings. Individual features of the different embodiments illustrated in the drawings and described in the description can be combined with one another as desired without exceeding the scope of the invention. In the drawings:

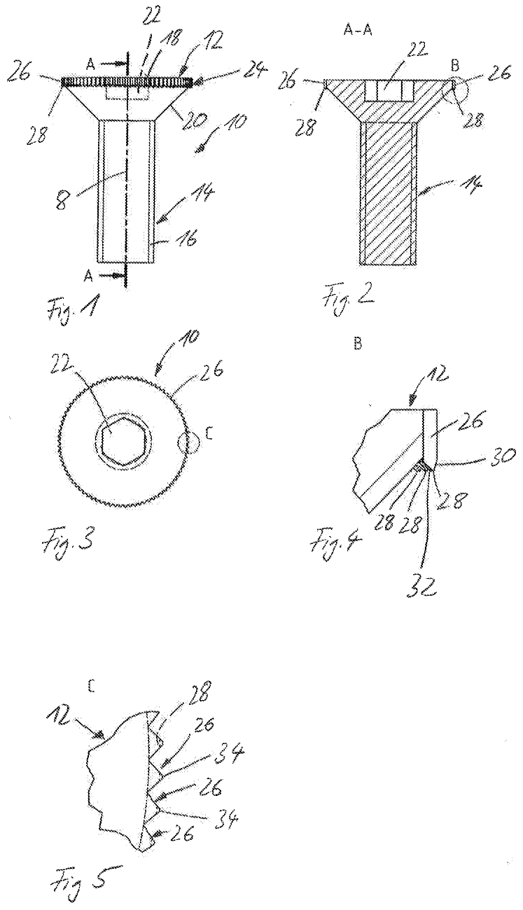

FIG. 1 shows a side view of a screw according to the invention according to a first embodiment,

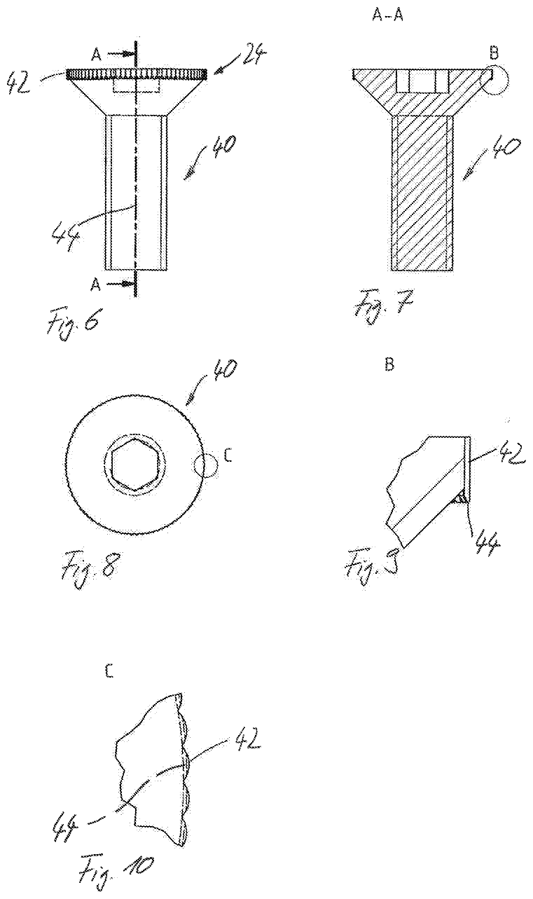

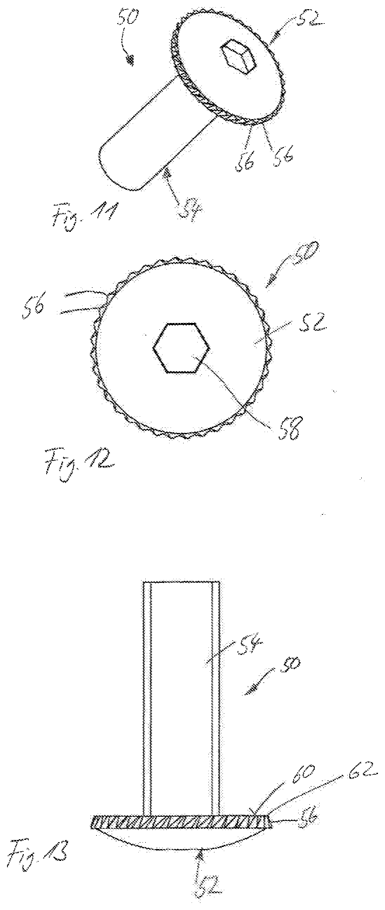

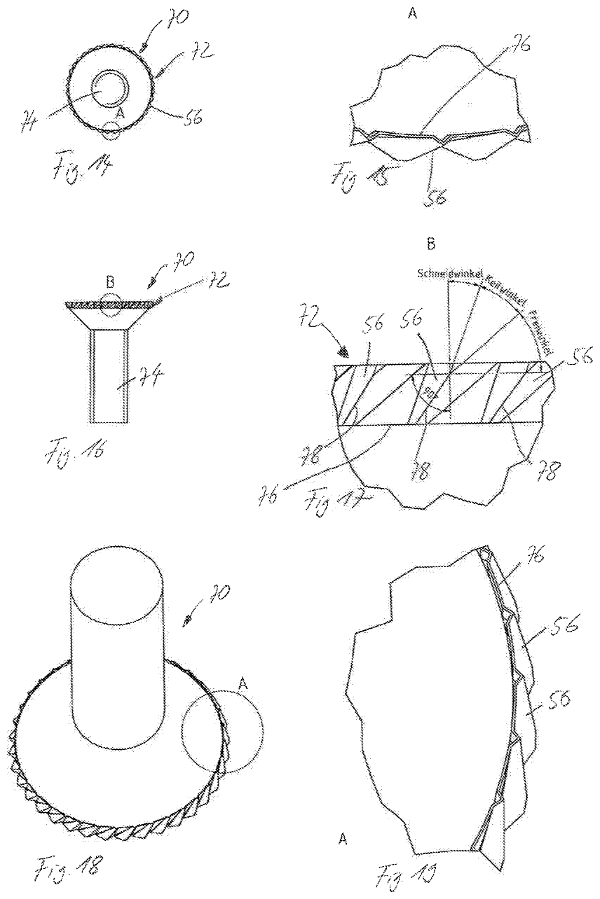

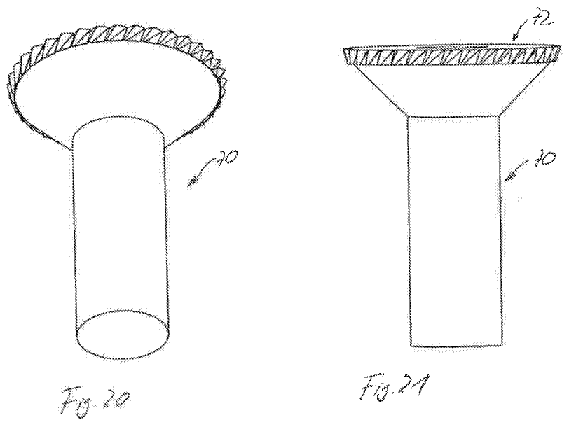

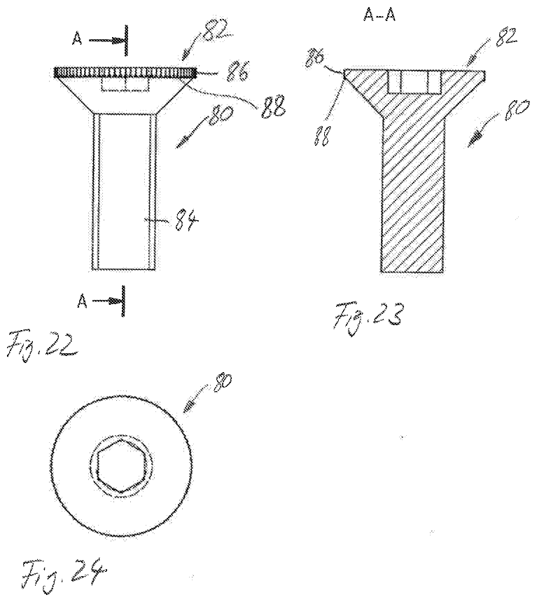

FIG. 2 shows a view on the section plane A-A in FIG. 1,

FIG. 3 shows a plan view of the screw according to the invention in FIG. 1,

FIG. 4 shows an enlarged illustration of the detail B in FIG. 2,

FIG. 5 shows an enlarged illustration of the detail C in FIG. 3,

FIG. 6 shows a side view of a screw according to the invention according to a further embodiment,

FIG. 7 shows a view on the section plane A-A in FIG. 6,

FIG. 8 shows a plan view of the screw according to the invention in FIG. 6,

FIG. 9 shows an enlarged illustration of the detail B in FIG. 7,

FIG. 10 shows the enlarged detail C from FIG. 8,

FIG. 11 shows a view obliquely from above of a screw according to the invention according to another embodiment,

FIG. 12 shows the screw in FIG. 11 from above,

FIG. 13 shows the screw in FIG. 11 from the side,

FIG. 14 shows a view from below of a screw according to the invention according to a further embodiment,

FIG. 15 shows the detail A from FIG. 14 in an enlarged illustration,

FIG. 16 shows the screw in FIG. 14 from the side,

FIG. 17 shows the detail B from FIG. 16 in an enlarged illustration,

FIG. 18 shows the screw in FIG. 14 obliquely from below,

FIG. 19 shows the detail A from FIG. 18 in an enlarged illustration,

FIG. 20 shows a further illustration of the screw in FIG. 14 obliquely from below,

FIG. 21 shows an illustration of the screw in FIG. 14 somewhat obliquely from above,

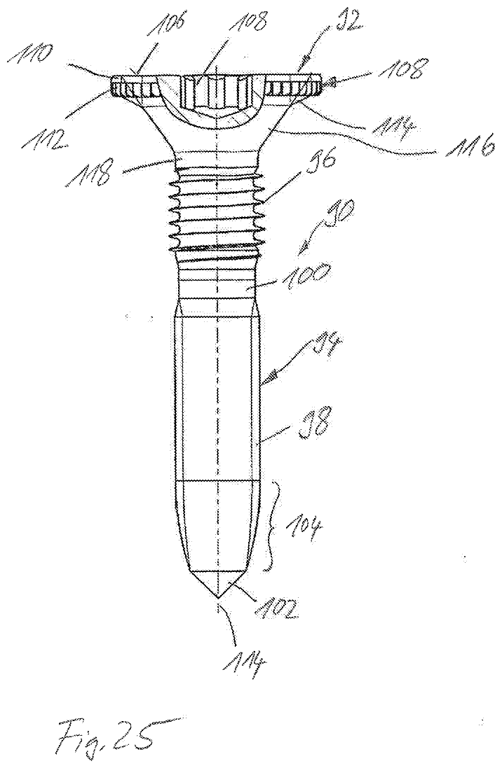

FIG. 22 shows a side view of a screw according to the invention according to a further embodiment,

FIG. 23 shows a view on the section plane A-A in FIG. 22,

FIG. 24 shows a view of the screw in FIG. 22 from above, and

FIG. 25 shows a side view in partial section of a screw according to the invention according to a further embodiment.

FIG. 1 shows a screw 10 according to the invention, having a screw head 12 and a screw shank 14, which is in the form of a countersunk screw. The screw shank 14 is provided with a thread 16. The screw shank 14 can adopt different configurations within the scope of the invention and have for example a hole-forming tip and a self-cutting or self-tapping thread. The thread 16 can also be for example in the form of a wood thread or sheet-metal thread. A longitudinal center axis 8 of the countersunk screw 10 is indicated in FIG. 1.

The screw head 12 has a planar top side 18 and an underside 20 located on the side of the screw shank 14. The underside 20 has a frustoconical shape. In the illustration in FIG. 1, a recess indicated by dashed lines is illustrated in the top side 18, said recess forming a driving configuration 22, a hexagon socket in the embodiment illustrated.

The screw head 12 is provided with a periphery 24 that is provided with a plurality of riblike protrusions 26 protruding in a radial direction. Each of the protrusions 26 has, at its lower end located on the side of the screw shank 14, a cutting edge 28, which is only indicated in the illustration in FIG. 1 but is readily apparent for example in FIG. 4.

FIG. 2 shows a view on the section plane A-A in FIG. 1. The driving configuration 22 in the form of a hexagon socket is readily apparent in this sectional view. Likewise readily apparent are two protrusions 26, each having a cutting edge 28 at their lower end.

FIG. 3 shows a plan view of the screw 10 in FIG. 1. The protrusions 26 extend in an axial direction, see also FIG. 5, and are arranged in a manner spaced apart uniformly from one another around the circumference of the periphery of the screw head 12.

FIG. 4 shows the enlarged detail B from FIG. 2. One of the protrusions 26 and the cutting edge 28 arranged at its lower end, located on the side of the screw shank 14, are readily apparent here. It is also apparent from FIG. 4 that the cutting edge 28 extends substantially in the circumferential direction. The two further cutting edges 28 that are likewise apparent in FIG. 4 are oriented substantially likewise in the circumferential direction. The cutting edge 28 is in this case offset inward with respect to a greatest outer circumference of the screw head 12. This is brought about in that the lower end of the protrusion 26 narrows and has, on its radially external side, a first bevel 30, which extends radially obliquely inward. On the radially inner side, the lower end of the protrusion 26 has a second bevel 32, which extends obliquely radially outward. The two bevels 30, 32 meet at the cutting edge 28.

The illustration in FIG. 5 shows the detail C from FIG. 3 in an enlarged illustration. A plurality of protrusions 26 are apparent, which, as has already been stated, are arranged at the periphery of the screw head 12 in a manner spaced apart uniformly from one another. The protrusions 26 each have a triangular shape and as a result each form a radially outwardly facing edge 34. While the screw head 12 is being screwed in, these edges 34 ensure a milling or scraping action in a drilled hole, created by means of the cutting edges 28 and the edges 34, in the surface or coating of the material into which the screw 10 is screwed. After the screw 10 has been screwed in fully, wherein the planar top side 18 of the screw head 12, see FIG. 1, is then arranged flush with the surface of the material into which the screw has been screwed, the coating or the region immediately adjoining the surface of the material can interlock or mesh with the protrusions 26, in order as a result to increase a loosening torque of the screw 10.

In the illustration in FIG. 5, the cutting edges 28 bear against the underside, which is not visible per se in FIG. 5, of the protrusions 26, but are indicated by dashed lines in FIG. 5. It is apparent that the cutting edges 28 are comparatively short in the circumferential direction. This is caused by the triangular cross section of the protrusions 26 and in that the cutting edges 28 are offset only slightly inward with respect to the radially external edges 34 of the protrusions 26. Specifically, the cutting edges 28 are offset inwardly by about a quarter of the radial extent of the protrusions 26 with respect to the radially external edges 34 in the embodiment illustrated.

If the screw 10, as is illustrated in FIGS. 1 to 5, is screwed into a thread, for example in a metal support located beneath veneer plywood provided with a linoleum coating, the cutting edges 28, shortly before the screw head 12 is countersunk fully in the material, come into contact with the linoleum coating and cut the latter open in a circle. If the screw 10 is then screwed in further, the linoleum coating is cut in a circle and can be pushed into the veneer plywood by the screw head 12. As a result of the linoleum coating being cut in a circle by means of the cutting edges 28, a situation is avoided in which the linoleum coating drops or even tears in the region surrounding the screw head 12. As a result, the breaking or tearing of the linoleum coating is avoided and in particular the ingress of moisture or water through the linoleum coating and the subsequent swelling of the veneer plywood is avoided. Furthermore, as a result of the circular cutting open of the linoleum coating, it is also possible that, after the screw 10 has been countersunk fully, a planar surface arises, since the regions of the linoleum coating that immediately adjoin the periphery 26 of the screw head 12 do not drop.

Shortly before the screw head 12 has been countersunk fully, the edges 34 of the protrusions 26 ensure that the linoleum coating is milled or scraped open cleanly. The linoleum coating has a certain elasticity, and so, after screwing in is complete, it penetrates into the intermediate spaces between the protrusions 26. As a result, a form fit between the linoleum coating and the protrusions 26 is achieved and in particular the ingress of water or moisture between the periphery 24 of the screw head 12 and the linoleum coating is prevented.

The screw 10 according to the invention can be used very advantageously not only in veneer plywood with a linoleum coating. The screw 10 can be countersunk for example also in hard or brittle uncoated materials or into materials that are provided generally with a hard and/or brittle coating. The cutting edges 28 at the lower ends of the protrusions 26 always ensure that the coating is cut open cleanly in a circle, such that breaking and resultant cracking of the coating in the region immediately surrounding the screw head 12 are entirely avoided.

As an alternative to the provision of cutting edges at the lower end of the protrusions 26, it is also possible for example for tips to be provided, which then likewise cut or scratch open the coating or the surface of the material.

The illustration in FIG. 6 shows a further embodiment of a screw 40 according to the invention. The screw 40 is constructed very similarly to the screw 10 in FIGS. 1 to 5, and so only the differences from the screw 10 are explained. The longitudinal center axis 44 is indicated in FIG. 6.

The periphery 24 of the screw 40 is provided with knurling in the form of a plurality of protrusions 42 spaced apart uniformly from one another in the circumferential direction. The protrusions 42 have, as seen in a direction parallel to a longitudinal center axis of the screw 40, see FIG. 10, a circle-segment-like cross section. As a result, in contrast to the protrusions 26 of the screw 10, see FIG. 5, the protrusions 42 do not form any radially external edges. As a result, the protrusions 42 also do not bring about a scraping or milling action in the material into which the screw 40 is screwed.

In the same way as the protrusions 26 of the screw 10, the protrusions 42 are provided at their lower end with cutting edges 44, however, which extend substantially parallel to the circumferential direction, see FIG. 9.

In the illustration in FIG. 10, the cutting edges 44 are concealed as such, but indicated by dashed lines. The cutting edges 44 are also offset slightly inward with respect to a maximum radial extent of the protrusions 42 and are formed by two bevels that are arranged at the lower end of the protrusions 42 and run towards the cutting edges 44.

The protrusions 42 are also rolled on to the periphery of the screw head of the screw 40. If necessary, after the protrusions 42 have been rolled on, the cutting edges 44 can be applied, for example by sharpening the lower ends of the protrusions 42.

The screw 40 can be used for coated materials or materials in which a milling action of the radially external portions of the protrusions 42 is not desired.

FIG. 11 shows a screw 50 according to a further embodiment of the invention, wherein the screw 50 is in the form of what is known as a round-head screw. The screw 50 has a screw head 52 and a shank 54, wherein the shank 54 is provided with a thread that is not illustrated. The screw head 52 is provided at its periphery with a plurality of cutting protrusions 56, which are in the form of cutting wedges.

FIG. 12 shows a view of the screw 50 from above. In this view, a driving configuration in the form of a hexagon socket is apparent in the top side of the screw head 52, and the arrangement of the cutting wedges 56 spaced apart uniformly from one another around the circumference of the screw head 52 is also apparent. The cutting wedges 56 each have an approximately triangular cross section, and, see also FIG. 13, are arranged obliquely with respect to the longitudinal center axis of the screw shank 54. A cross-sectional area of the individual protrusions 56 decreases here in the direction of the free end of the screw shank, see FIG. 13.

It is also readily apparent from FIG. 13 that an underside 60 of the screw head, from which the shank 54 proceeds, is formed in a planar manner. A top side of the screw head 52, by contrast, is formed in a rounded or domed manner. For this reason, the screw 50 is known as a round-head screw or mushroom head screw. Arranged at the end of the cutting protrusions 56 that faces the screw shank 54 are in each case cutting edges 62, which, however, in the illustrations in FIGS. 11 to 13, are discernible only to some extent in the side view in FIG. 13.

The illustration in FIG. 14 shows a view of a further screw 70 according to the invention from below. The screw 70 has a screw head 72 and a screw shank 74, which is provided with a thread. Arranged at the circumference of the screw head 72 are a plurality of cutting protrusions 56, which are spaced apart uniformly from one another in the circumferential direction and are configured identically to the cutting protrusions 56 of the screw 50 in FIGS. 11 to 13. Specifically, the cutting protrusions 56 are in the form of cutting wedges, which are arranged obliquely with respect to the longitudinal center axis of the shank 74 and the triangular cross-sectional area of which also decreases in the direction of the free end of the shank 74.

The illustration in FIG. 15 shows the detail A from FIG. 14 in an enlarged manner. Apparent here are the ends, projecting beyond the periphery of the screw head 72 in the direction of the shank 74, of the cutting protrusions 56, which form a circumferential cutting edge 76. The cutting edge 76 extends partially around a circular circumference and partially has a triangular shape, wherein the tip of the triangle extends radially outward.

FIG. 16 shows a side view of the screw 70 in FIG. 14. It is apparent that the top side of the screw head 72 is formed in a planar manner, whereas the underside is frustoconical.

FIG. 17 shows the detail B from FIG. 16 in an enlarged illustration. It is apparent that the individual cutting protrusions 56 are each in the form of cutting wedges, the triangular cross section of which decreases in the direction of the screw shank 74, i.e. downward in FIG. 17. It is also apparent that an external edge 78 of the cutting protrusions 56 is arranged in each case obliquely with respect to the longitudinal center axis of the shank 74. In the region of the transition into the top side of the screw head 72, the cutting edge 78 is broken, such that a triangular geometry arises there.

In FIG. 17, three angles are indicated that jointly determine the geometry of the cutting protrusions 56. These are the cutting angle, the wedge angle and the clearance angle of the cutting protrusions 56.

At their lower end in FIG. 17, the cutting edge 76, which is not readily apparent, is then arranged.

FIG. 18 shows a further view of the screw 70 in FIG. 14 obliquely from below.

FIG. 19 shows the detail A from FIG. 18 in an enlarged illustration.

Readily apparent here is the circumferential cutting edge 76 with the circle-segment-like and triangular portions. The triangular portions each form the lower end of a cutting protrusion 56.

The illustrations in FIGS. 20 and 21 show further views of the screw 70 according to the invention. In the illustration in FIG. 21, a driving configuration in the planar top side of the screw head 72 is apparent.

The illustration in FIG. 22 shows a screw 80 according to the invention according to a further embodiment of the invention. The screw 80 is in the form of a countersunk screw and has a screw head 82 with a planar top side and a frustoconical underside. The periphery of the screw head 82 is provided with a plurality of protrusions 86 spaced apart uniformly from one another. At their lower ends, the protrusions 86 each form cutting edges 88, which project parallel to the longitudinal center axis of the screw shank 84.

In the view on the section plane A-A in FIG. 22, which is illustrated in FIG. 23, these cutting edges 88 are indicated. In the top side of its screw head 82, the screw 80 has a driving configuration in the form of a hexagon socket.

FIG. 24 shows the screw 80 in a view from above. The protrusions 86 are each formed in an imbricated manner, as is also suggested in FIG. 24.

FIG. 25 shows a screw 90 according to a further embodiment of the invention in partial section. The illustration in FIG. 25 is partially schematic, specifically the thread adjoining the screw tip is illustrated only schematically.

The screw 90 can be used for example to fasten floor panels to a substructure of loading compartments of trucks or trailers for trucks. The floor panels are embodied as a rule as what are known as film-coated plywood panels and are fastened to a metal substructure. A problem with such an application is that, when conventional surfaces are used, the hard surface of the film-coated plywood panels breaks during the countersinking of the screws and deforms as a result. This causes fracture points at which water can pass into the floor panels. Under unfavorable conditions, the film-coated plywood panel can then swell in the region surrounding the screw head.

Furthermore, such fastenings of floor panels are subject to considerable loads, in particular in the form of torsions and vibrations, when the trucks are being driven. When conventional screws are used, this can result in loosening of the screws.

The screw 90 according to the invention has a screw head 92 and a screw shank 94. The screw shank 94 is provided with a first thread portion 96 and a second thread portion 98, wherein a thread-free, cylindrical portion 100 is arranged between the two thread portions 96, 98. The second thread portion 98 is followed in the direction of the end of the screw shank 94 opposite to the screw head 92 by a conical tip 102.

As seen in the direction of the screw head 92, the conical tip 102 is adjoined by a thread-forming portion 104, which forms part of the second thread portion 98 and in which a flank height of the thread increases from a value of 0 to the final flank height of the thread. As seen in the longitudinal direction of the screw, the thread-forming region 104 is somewhat longer than the core diameter of the screw shank and has in particular around 1.5 times the length of the core diameter of the screw shank. The thread-free portion 100 likewise exhibits the core diameter of the screw shank. The pitches of the thread in the first thread portion 96 and in the second thread portion 98 are identical.

In the first thread portion 96, the thread has a larger outside diameter than in the second thread portion 98. The screw 90 according to the invention is provided for example for fastening floor panels to a substructure of loading compartments. The first thread portion 96 is then arranged in the floor panel in the fully screwed-in state of the screw 90. The floor panel is in the form for example of a film-coated plywood panel, generally of a wooden panel or plastics panel, and the first thread portion 96 is then securely anchored in this floor panel. This is also brought about in that the outside diameter of the thread of the first thread portion 96 is greater than the outside diameter of the thread of the second thread portion 98. Once the second thread portion 98 has been screwed through the block floor panel, an internal thread is already formed in the floor panel. Since the thread of the second thread portion has a larger outside diameter than the thread of the first thread portion 96, the second thread portion 96 forms the thread in the floor panel even further and the screw 90 is thus firmly anchored in the floor panel. In particular, the loosening torque of the screw 90 is increased considerably compared with conventional screws, since the first thread portion 98 having a larger outside diameter than the second thread portion 98 is anchored particularly securely in the floor panel. A further increase in the loosening torque compared with conventional screws is ensured, as already mentioned, by the specific configuration of the periphery 108 of the screw head 92 with the protrusions, protruding in a radial direction, in the second portion 112. The thread of the first thread portion 96 has thread turns with a flank angle of 30°. As a result of such a comparatively small flank angle, the outside diameter of the thread in the first thread portion 96 can be increased, with the same core diameter as in the second thread portion.

In the second thread portion 98, the flank angle of the thread is for example 60°. In the embodiment illustrated, a metric thread is provided in the second thread portion 98.

Within the scope of the invention, the larger outside diameter of the thread in the first thread portion 96 compared with the second thread portion 98 can also be achieved in some other way than by changing the flank angle, for example by different outside diameters of a blank for the screw 90.

Within the scope of the invention, the thread-free portion 100 can be dispensed with. A transition from the metric thread in the second thread portion 98 to the thread with a 30° flank angle in the first thread portion 96 can also occur without any interruption of the thread.

In order to fasten floor panels or other workpieces using the screw 90 according to the invention, first of all the workpiece, for example the film-coated plywood panel, and the substructure are predrilled. What is introduced is an in particular cylindrical bore, the diameter of which corresponds approximately to, and in particular is somewhat smaller than, the flank diameter of the thread in the second thread portion 98. While the screw is being screwed into the assembly made up of the workpiece to be fastened, in particular the floor panel, and the substructure, the thread forms, by means of the forming portion 104 or tapping portion, a thread both in the bore of the floor panel and in the substructure. In the floor panel or the workpiece to be fastened, the first thread portion 96 follows the second thread portion 98 and reworks the internal thread of smaller outside diameter, which was formed in the floor panel by the second thread portion 98. The screw thus jams additionally in the floor panel or the workpiece to be fastened, on account of the greater outside diameter of the thread in the thread portion 96. In the substructure, the thread of the second thread portion 98 finds a secure hold. Compared with conventional screws, the screw 90 according to the invention thus has an increased connection strength and in particular a much higher loosening torque. Precisely for the fastening of floor panels to loading compartments of commercial vehicles, an extremely secure connection is thus created.

From the top side 106 of the screw head 92, which is formed in a planar manner, there proceeds a driving recess 108, which is provided for the insertion of a screwdriver bit. The driving recess 108 is in the form of a torx driving recess in the embodiment illustrated.

The top side 106 of the screw head 92 is adjoined by a periphery 108 of the screw head. The periphery 108 has a first portion 110, which immediately adjoins the top side 106 of the screw head 92 and is formed in a smooth manner. In the direction of the screw tip 102, the first portion 110 is adjoined by a second portion 112 of the periphery 108 of the screw head 92, in which a plurality of riblike protrusions protruding in a radial direction are provided. The riblike protrusions each have a triangular cross section and extend parallel to a longitudinal center axis 114 of the screw 90.

In the screw 90, the riblike protrusions are beveled at their lower end in the second portion 112 of the periphery 108. The lower end of the riblike protrusions can, however, also be provided with a rib or cutting edge, as is illustrated for example in FIG. 4. The shape of the riblike protrusions in the second portion 112 can otherwise be formed in a manner corresponding to the further embodiments in FIGS. 1 to 24 of the present application.

As seen in the longitudinal direction of the screw 90, a height of the first portion 110 of the periphery 108 corresponds approximately to the thread pitch of the first thread portion 96. During the last turn or the last two turns of the screw 90, i.e. just before the top side 106 of the screw head 92 is arranged flush with the top side of the floor panels, into which the screw 90 is being screwed, the smooth first portion 110 then passes into the region of the inner wall of the bore that was created in the second portion 112 of the periphery 108 by means of the radially protruding protrusions. This inner wall of the bore produced can then bear against the circumferential surface of the first portion 110, and as a result provide a seal of the interface between the periphery 108 of the screw head 92 and the inner wall of the bore or the surface of the floor panels. At the same time, the riblike protrusions protruding in a radial direction in the second portion 112 of the periphery 108 ensure a loosening torque of the screw 90 that is much greater compared with conventional screws. Even in the event of large stresses, for example torsions and vibrations when a truck is being driven, the screw 90 thus does not loosen.

The periphery 108 of the screw head 92 is adjoined by a first frustoconical region 114 with a comparatively large cone angle but a smaller height, when is then followed by a second frustoconical portion 116 with a much greater height but a reduced cone angle. As seen in the direction of the tip 102 of the screw 90, the second frustoconical portion 116 is followed by the cylindrical screw shank 94, wherein first of all a thread-free cylindrical portion 118 is provided. The cylindrical portion 118 is followed by the first thread portion 96, which is then in turn followed, as mentioned above, by the thread-free portion 100 and then the second thread portion 98. Adjoining to the thread-forming region 104 of the second thread portion 98 the conical tip 102 of the screw 90 then follows.

Starting from the thread-free portion 100, the flank height of the thread in the first thread portion 96 increases in the direction of the screw head 92 from the height of 0 to the final value. In the opposite direction, starting from the thread-free portion 100, the flank height of the thread in the second thread portion 98 increases from a value of 0 to the final value. Both at the transition from the thread-free portion 100 to the first thread portion 96 and at the transition from the thread-free portion 100 to the second thread portion 98, the flank height increases to the final value in the course of about one turn of the thread.

As has already been mentioned, in the thread-forming region 104, by contrast, starting from the tip 102, the flank height of the thread increases from a value of 0 to the final value of the flank height over about eight to 10 turns.

In addition to the abovementioned use of the screw 90 for fastening floor panels in loading compartments of commercial vehicles, trucks or trailers, the screw 90 according to the invention can also be used very advantageously in the fastening of concrete formwork or the fastening of floor panels for work platforms. In general, wooden components, plastics components or fiber-material components can be fastened particularly advantageously with the screw according to the invention. This applies in particular when these components are provided with a hard surface or a hard coating.

1. A screw having a screw head and a screw shank, wherein the screw shank is provided at least partially with a thread, wherein a periphery of the screw head is provided with a plurality of riblike protrusions protruding in a radial direction.

2. The screw as claimed in claim 1, wherein the lower end, located on the side of the screw shank, of each protrusion is provided with a tip and/or cutting edge.

3. The screw as claimed in claim 2, wherein the tip and/or cutting edge is located at the front in the screw-in direction of the screw.

4. The screw as claimed in claim 2, wherein the cutting edge extends substantially parallel to the circumference of the screw head.

5. The screw as claimed in claim 1, wherein the tips and/or cutting edges are offset radially inward with respect to the outer circumference of the screw head.

6. The screw as claimed in claim 1, wherein the protrusions are in the form of cutting protrusions.

7. The screw as claimed in claim 6, wherein the cutting protrusions are in the form of knurling rolled on to the periphery of the screw head.

8. The screw as claimed in claim 6, wherein the cutting protrusions intersect one another.

9. The screw as claimed in claim 1, wherein the protrusions extend parallel to the longitudinal center axis of the screw shank.

10. The screw as claimed in claim 1, wherein the protrusions extend obliquely with respect to the longitudinal center axis of the screw shank.

11. The screw as claimed in claim 1, wherein the protrusions extend at different angles to the longitudinal center axis.

12. The screw as claimed in claim 11, wherein the protrusions at least partially intersect one another.

13. The screw as claimed in claim 1, wherein the protrusions, as seen in an axial direction parallel to the longitudinal center axis of the screw shank, at least partially have a triangular cross section.

14. The screw as claimed in claim 1, wherein the protrusions, as seen in an axial direction parallel to the longitudinal center axis of the screw shank, at least partially have a circle-segment-like cross section.

15. The screw as claimed in claim 1, wherein the riblike protrusions, as seen in the longitudinal direction of the screw, extend only over a second portion of the periphery of the screw head that is spaced apart from the top side of the screw head, and no riblike protrusions are provided in a lower portion of the periphery of the screw head immediately adjoining the top side of the screw head.

16. The screw as claimed in claim 15, wherein the first portion of the screw head immediately adjoining the top side is formed in a smooth manner.

17. The screw as claimed in claim 15, wherein the first portion has a height that lies between the value of the thread pitch and twice the value of the thread pitch.

18. The screw as claimed in claim 1, wherein the screw is in the form of a countersunk screw and an underside of the screw head located on the side of the screw shank is formed in a frustoconical manner.

19. The screw as claimed in claim 1, wherein the thread on the screw shank has two portions, between which a thread-free portion of the screw shank is arranged.

20. The screw as claimed in claim 1, wherein the thread on the screw shank has two thread portions, wherein a thread portion located closer to the screw head has a thread with a larger outside diameter than an outside diameter of a thread in a thread portion located further away from the screw head.
